(19) United States
(12) Patent Application Publication
(10) Pub. No.: US 2006/0005778 A1
(43) Pub. Date: Jan. 12, 2006

(54) Method and device for cultivating and maintaining aquatic crustaceans

(75) Inventor: Shyh Min Hsiao, Taipei (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsin Chu (TW)

(21) Appl. No.: 11/224,227

(22) Filed: Sep. 13, 2005

Related U.S. Application Data
(62) Division of application No. 10/738,045, filed on Dec. 18, 2003.

(51) Int. Cl. A01K 61/00

(52) U.S. Cl. 119/207

(57) ABSTRACT

A device for cultivating and maintaining aquatic crustaceans and the method for the same are provided, whereby aquatic crustaceans are cultured in a culture tank having at least one effective resting and/or hiding area that provides visual only or both visual and tactile sensations for aquatic crustaceans. The present invention creates effective resting and/or hiding areas by utilizing the sensitivity of aquatic crustaceans to physical environment, thereby allowing aquatic crustaceans to live within confined spaces in high densities without cannibalizing those fall outside the effective resting and/or hiding areas (the non-effective habitat areas). The device of the present invention can cultivate and maintain aquatic crustaceans successfully in shallow waters and a plurality of which may be vertically incorporated into a multi-layered culture system to bring about higher culture and maintenance densities per unit floor area.

### BACKGROUND OF THE INVENTION

1. Field of the Invention

The present invention relates to a method and a device for cultivating and maintaining aquatic crustaceans, characterized in which through the construction of a culture tank having at least one effective resting and/or hiding area for aquatic crustaceans therein to live in high densities without cannibalizing each other, and hence attaining high yield.

2. Description of Related Art

Traditional aquaculture makes use of wide expanse of land and ponds with natural water supply. But due to the lack of environmental planning, such culturing practice gradually caused changes to biotic communities in the natural environment and brought pollution and havoc to the ecosystems. In addition, the culturing areas became epidemic zones infested with pathogens due to the lack of sanitary protection. Later on, the new generation aquaculturiests gradually switch to factory style culturing, using water recirculation and filtering apparatus to cut down the consumption of resources and damages to the natural environment. Protective measures were also taken to control the invasion of pathogens (including parasites, bacteria and viruses) into the culture facilities. Given that the new generation aquaculture facilities cost more, the yield per unit floor area becomes the key to whether the new facilities are commercially viable.

To enhance space utilization and thus to bring about greater profit, current culturing of marine shrimp (for example, Litopenaeus vannamei, Penaeus monodon, and Penaeus japonicus) resorts to several ways to boost the culture density per unit area, for example, increasing the stocking of shrimp fry in deep-water pond or water tank (about 0.6 to 2.0 m deep in general) or adding a variety of habitat structures, including hollow tubing, hanging screen mesh, and single-layer or multi-layer horizontal screen mesh, in addition to increasing the stocking of shrimp fry. A common drawback of the two methods for increasing the culture density of marine shrimp just described is that the marine shrimp face the threat of being cannibalized by other shrimp during molting. Because marine shrimp go through the molting stage in their growth process and their shells remain soft right after molting, they become unable to carry out directional mobility except simple backward and upward jumping. Under high culture densities, the soft-shelled shrimp, unable to hide away, are susceptible to the attack of other shrimp in the tank, leading to severe mortality. Even marine shrimp reared in ponds having habitat structure erected may be cannibalized when they undergo molting for they are unable to enter the protective habitat due to the lack of directional mobility. This cannibalization phenomenon that causes death of marine shrimp is the bottleneck in the efforts to increase the culture density.

In addition, when marine shrimp shed the shell, their body jump back or up away from the old shell and so as to escape from the attack of other shrimp mates. Thus the culture pond or tank must maintain a certain water depth, at about 0.6 to 2.0 m in order to reduce the incidence of cannibalizing behavior. Culture tanks with such depths tend to be heavy and cumbersome, rendering the attempt to build a structure with two or more layers of tank difficult and costly. Thus presently regular culture ponds or tanks typically have one plane, making it hard to enhance the efficiency of space utilization, which poses another bottleneck for raising the culture density.

Due to the lack of proper marine shrimp indoor culturing techniques and environment, laboratories and schools still rely heavily on poorly controlled outdoor ponds for the study of such shrimp. Marine shrimp markets and restaurants are also faced with the same problems and are unable to maintain and display live marine shrimp effectively. The high-density cultivation device in the present invention similarly offers the laboratories, schools, markets and restaurants an effective solution to the cultivation and maintenance of marine shrimp.

In light of the needs of the marine shrimp culture industry and other sectors, it is a pressing task to develop a cultivating and maintaining apparatus that can keep the marine shrimp from being cannibalized during molting and help reduce the depth during cultivation and increase the culture density.

### SUMMARY OF THE INVENTION

In addressing the drawbacks of prior arts, the present invention aims to provide a device for cultivating and maintaining aquatic crustaceans, which comprises a culture tank; and at least one effective resting and/or hiding area, wherein aforesaid effective resting and/or hiding area refers to the area that provides visual only or both visual and tactile sensations for aquatic crustaceans.

The aforesaid cultivation and maintenance of aquatic crustaceans includes the cultivation and maintenance during the growing stage and mature stage of aquatic crustaceans.

The aforesaid visual sensations are created by static or dynamic alternating or contrasting light effects spreading over water body of the resting/hiding area within the culture tank, wherein the aforesaid static or dynamic alternating or contrasting light effects are created by lighting arrangements or light going through perforated filters above or within the water or light reflecting from grids marked on the bottom of the resting and/or hiding area.

The aforesaid tactile sensations are provided with shelter structures touchable by aquatic crustaceans. The aforesaid device for cultivating and maintaining aquatic crustaceans, if necessary, may be further coupled with currently available aquaculture equipment, including aeration system, physical filtering equipment, biochemical equipment, flow control piping or water delivery motor.

Furthermore, a plurality of the aforesaid devices for cultivating and maintaining aquatic crustaceans may be vertically arranged to form a multi-layered culture system to enhance the efficiency of space utilization and increase the culture density per unit floor area.

The aforesaid aquatic crustaceans are shrimp and crab, wherein Litopenaeus vannamei, Penaeus monodon, and Penaeus japonicus, are more preferable.

Another object of the present invention is to provide a multi-layered culture system for cultivating and maintaining aquatic crustaceans, comprising a plurality of culture tanks; and a plurality of effective resting and/or hiding areas that provide visual only or both visual and tactile sensations for aquatic crustaceans.

The aforesaid visual sensations are created by static or dynamic alternating or contrasting light effects spreading over water body of the resting/hiding area within the culture tank, wherein the aforesaid static or dynamic alternating or contrasting light effects are created by lighting arrangements or light going through perforated filters above or within the water or light reflecting from grids marked on the bottom of the resting and/or hiding area.

The aforesaid tactile sensations are provided with shelter structures touchable by aquatic crustaceans.

The aforesaid device for cultivating and maintaining aquatic crustaceans, if necessary, may be further coupled with currently available aquaculture equipment, including aeration system, physical filtering equipment, biochemical equipment, flow control piping or water delivery motor.

Furthermore, a plurality of the aforesaid devices for cultivating and maintaining aquatic crustaceans may be vertically arranged to form a multi-layered culture system to enhance the efficiency of space utilization and increase the culture density per unit area.

The aforesaid aquatic crustaceans are shrimp and crab, wherein Litopenaeus vannamei, Penaeus monodon, and Penaeus japonicus, are more preferable.

Yet another object of the present invention is to provide a method for cultivating and maintaining aquatic crustaceans, comprising the following steps: obtaining live aquatic crustaceans; and cultivating the live aquatic crustaceans in a culture tank with water body having at least one effective resting/hiding area that provides visual only or visual and tactile both sensations for the aquatic crustaceans.

The aforesaid visual sensations are created by static or dynamic alternating or contrasting light effects spreading over water body of the resting/hiding area within the culture tank, wherein the aforesaid static or dynamic alternating or contrasting light effects are created by lighting arrangements or light going through perforated filters above or within the water or light reflecting from grids marked on the bottom of the resting and/or hiding area.

The aforesaid tactile sensations are provided with shelter structures touchable by aquatic crustaceans.

The aforesaid device for cultivating and maintaining aquatic crustaceans, if necessary, may be further coupled with currently available aquaculture equipment, including aeration system, physical filtering equipment, biochemical equipment, flow control piping or water delivery motor.

The aforesaid method for cultivating and maintaining aquatic crustaceans, if necessary, may be further coupled with currently available aquaculture equipment, including aeration system, physical filtering equipment, chemical filtering equipment, flow control piping or water delivery motor.

The aforesaid aquatic crustaceans are shrimp and crab, wherein Litopenaeus vannamei, Penaeus monodon, and Penaeus japonicus are more preferable.

### BRIEF DESCRIPTION OF THE PREFERRED EMBODIMENTS

The present invention is further depicted with the illustration of embodiments.

Embodiment 1—Building a cultivating and maintaining device (I) providing the water body having at least one effective resting and/or hiding area for aquatic crustaceans.

In the nature, many aquatic crustaceans, such as shrimp, live in a habitat environment with bright-dark alternating or contrasting lighting effects. The present invention provides an aquatic crustaceans cultivating and maintaining device 1 having such an environment as shown in FIG. 1 by creating an effective resting and/or hiding area 21 having bright-dark alternating and contrasting lighting in an area of the culture tank 2. In such an environment, shrimp may live in high densities without attacking and cannibalizing each other. In addition, the evenly luminous zone in the culture tank 2 is the non-effective habitat area 22, which is arranged to provide shrimp with soft shell after molting a place to stay away from the attack of other shrimp. A method of creating an effective resting and/or hiding area 21 having bright-dark alternating and contrasting lighting is to set up an opaque, perforated plate 3 made of PVC material and having a plurality of holes 31. Therefore light will only penetrates through holes 31 to reach the bottom of culture tank 2 to form an effective resting and/or hiding area 21 having bright-dark alternating and contrasting lighting. Shrimp staying at the bottom of the tank will sense the light contrast and converge in the area. On the other hand, shrimp undergoing molting will jump out of the effective resting and/or hiding area 21 as they coil and spring backward away from the old shell and fall to the evenly luminous non-effective habitat area 22 having uniform lighting and without light contrast to keep themselves from the attack of other shrimp. In addition, if the culture tank 2 has a large area, a second or more opaque, perforated plates 3 (as shown in FIG. 2) may be set up to provide more effective resting and/or hiding area 21 and non-effective habitat areas 22 for the shrimp. Furthermore, the other aspect is to place the aforesaid opaque, perforated plates 3 underwater inside the culture tank 2. Therefore, in addition to light contrast, the opaque, perforated plates 3 also provides tactile sensations for shrimp when they move close, so as to attract the habitation of shrimp under the opaque, perforated plates 3 without cannibalizing each other. As a result, the yield will increase.

Embodiment 2 Building a cultivating and maintaining device (II) providing the water body having an effective resting and/or hiding area with bright-dark alternating and contrasting lighting effect

FIG. 3 shows another device 1 for cultivating and maintaining aquatic crustaceans having bright-dark alternating and contrasting light effect, wherein grids 4 marked on the bottom of culture tank 2 is created using dark-colored adhesive tape or paint. Lights projecting onto the grids 4 marked on the bottom of culture tank 2 will reflect in the water body. As such, the bright-dark alternating and contrasting lighting effect will be generated to attract the habitation of shrimp. Furthermore, any form of shelter structures may be further provided onto the aforesaid grids 4, so as to provide the shrimp tactile sensations by their touching the aforesaid shelter structures when they move around, and to attract their habitation inside the effective habitat area without cannibalizing each other. As a result, the yield will increase.

Cultivating and maintaining shrimp in the water body having bright-dark alternating and contrasting lighting effects designed according to the present invention can keep the shrimp from cannibalizing each other even in shallow water. Thus deep-water culture tanks necessary in conventional culture technique are no more required in the present invention. The water depth of culture tank in the two embodiments described above can largely reduced and the exact depth of a culture tank can vary according to the species and size of aquatic crustaceans reared in practice without specific limitation. The device for cultivating and maintaining aquatic crustaceans of the present invention may be coupled with currently available aquaculture equipment, including aeration system, physical filtering equipment, biochemical filtering equipment, flow control piping or water delivery motor to provide an ideal culture environment.

Embodiment 3 A multi-layered shrimp culture system

FIG. 4 shows the lateral view of a multi-layered shrimp culture system 5 consisting of a plurality of vertically-integrated cultivating and maintaining devices 1 or 1 of the present invention. In this embodiment, only three layers of cultivating and maintaining device 1 or 1 are shown, while in actual operation, there may be ten layers of devices or more. The arrows in the figure illustrate the flow direction; this culture system 5 has water inlets 6 and water outlets 7. Besides the cultivating and maintaining device 1 or 1 the multi-layered culture system 5 of the present invention may further include a first-stage aeration and physical filtering system 8, physical filtering equipment 9, second-stage aeration 10, biochemical filtering equipment 11, and water delivery motor 12 to construct a complete multi-layered culture system 5. Through the design of multi-layered culture system 5, the culture density per unit area is greatly increased, so is the economic benefit thereof.

Experiment Results:

Table 1 below depicts the results of culturing Litopenaeus vannamei using a 10-layer culture system. The culture density is calculated by the total weight of shrimp in 10 layers of culture tanks divided by the square area of the culture system. It is found that using the multi-layered culture system (10 layers) of the present invention we can attain a very high culture density of 10 kg Litopenaeus vannamei per square meter or higher, which is a significant improvement over the density of 0.73 kg marine shrimp per square meter (calculated by the data published in the annual report of Taiwan, R.O.C. Council of Agricultural Affairs on fishery that in 1987, the most successful year of marine shrimp culture in Taiwan, the yield was 80,000 tons for 11,000 hectares of land used).

TABLE 1

| | | | | | |
|---|---|---|---|---|---|
| | | Weight per | Weekly | Survival | Total number |
| | Density* | shrimp | growth | rate | of shrimp in |
| Date | (kg/m²) | (gram) | (%) | (%) | sampled layer |

1. Growth progression data of white shrimp (Litopenaeus vannamei) juveniles in one test group

| | | | | | |
|---|---|---|---|---|---|
| 02/12/2001 | 3.89 | 0.86 | | | 448 |
| 02/19/001 | 4.7 | 1.05 | 22 | 99.11 | 444 |
| 02/26/2001 | 6.72 | 1.52 | 45 | 98.87 | 439 |
| 03/05/2001 | 9.18 | 2.09 | 39 | 99.09 | 435 |
| 03/12/2001 | 10.42 | 2.43 | 16 | 97.47 | 424 |

2. Data of juvenile white shrimp growing into young shrimp in one test group

| | | | | | |
|---|---|---|---|---|---|
| 03/26/2001 | 9 | 2.8 | | | 318 |
| 04/02/2001 | 11.26 | 3.52 | 25 | 99.69 | 317 |
| 04/09/2001 | 13.59 | 4.27 | 21 | 99.37 | 315 |

3. Growth progression data of young white shrimp in one test group

| | | | | | |
|---|---|---|---|---|---|
| 03/19/2001 | 10.72 | 4.41 | | | 251 |
| 03/26/2001 | 12.48 | 5.04 | 14 | 97.61 | 245 |
| 04/02/2001 | 13.18 | 5.44 | 8 | 97.96 | 240 |

4. Summary data of growing large white shrimp in two test groups

| | | | | | |
|---|---|---|---|---|---|
| April 2001 | 22.2 | 17.0-17.9 | 3.3 | 100 | 47 |
| (11 days) | | | | | |
| April 2000 | 19.3 | 16.1-17.4 | 5.0 | 100 | 42 |
| (12 days) | | | | | |

*Density is calculated as in 10-layer culture systems.

The culture method of the present invention entails the construction of a culture tank having at least one effective resting and/or hiding area that provides visual only or both visual and tactile sensations to effectively induce aquatic crustaceans to live in a flat, confined space in high densities. The water depth of the culture tank may be substantially reduced to 10 cm or near 10 cm while preventing the death of aquatic crustaceans as a result of cannibalization. The size and depth of culture tank can vary according to the species and size of aquatic crustaceans reared in practice without specific limitation. Given that weight of the water body is not too heavy with a low water level, the aquaculture farmers can turn such shallow-water device into multiple layers in an economically viable fashion to increase the yield per unit floor area. In addition, this novel high-density culture facilities provide an effective aquatic crustacean maintenance technique for research or teaching laboratories and classrooms or display of aquatic crustaceans. It meets the demands for convenient supply of aquatic crustaceans and allows the works of handling aquatic crustaceans, storage, distribution and display in the seafood market to be conducted effectively.

### BRIEF DESCRIPTION OF THE DRAWINGS

FIG. 1 is a diagram of cultivating and maintaining device for aquatic crustaceans in Embodiment 1 according to the present invention.

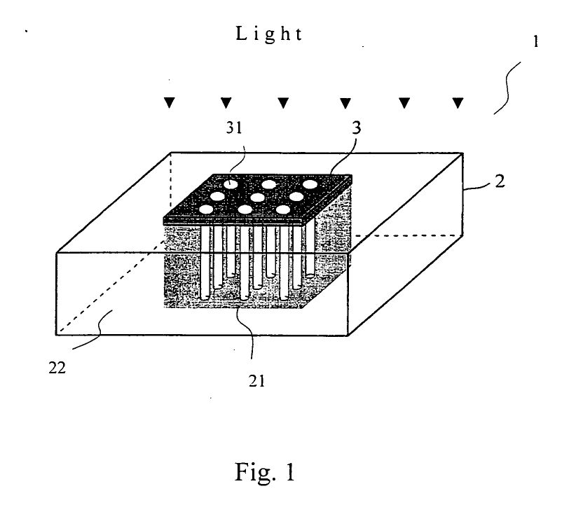

FIG. 2 is a diagram of cultivating and maintaining device for aquatic crustaceans with two perforated plates in Embodiment 1 according to the present invention.

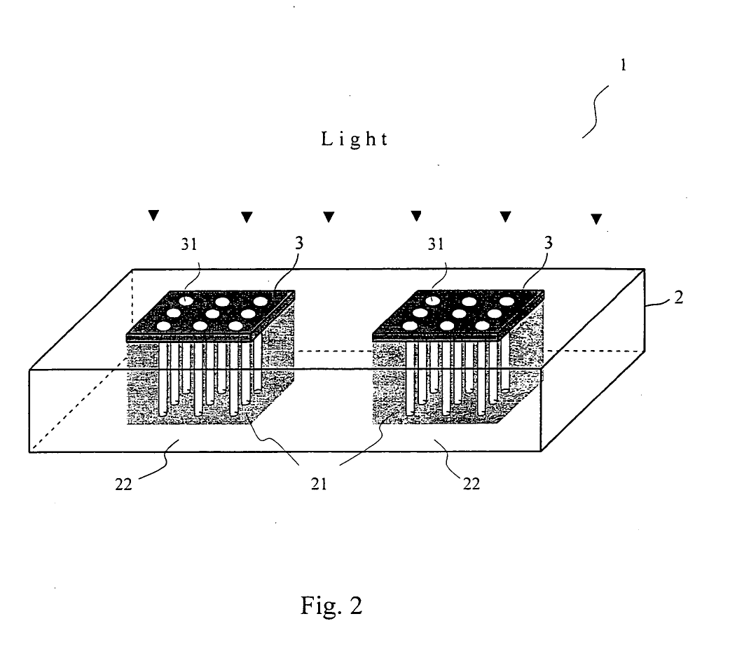

FIG. 3 is a diagram of cultivating and maintaining device for aquatic crustaceans in Embodiment 2 according to the present invention.

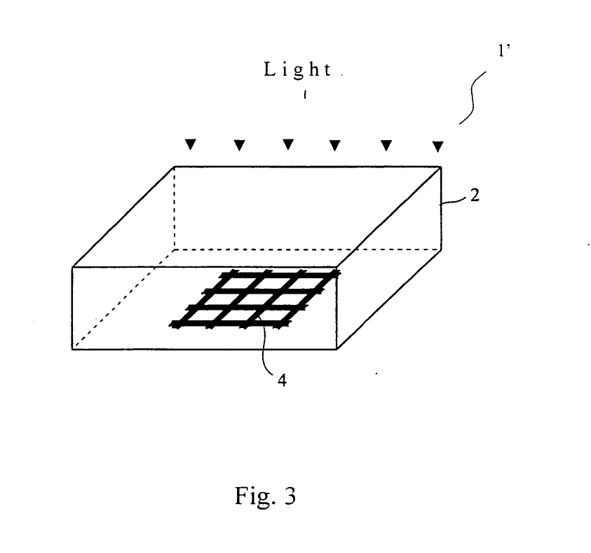

FIG. 4 is the lateral view of a multi-layered culture system for cultivating and maintaining aquatic crustaceans in high densities per unit floor area according to the present invention.

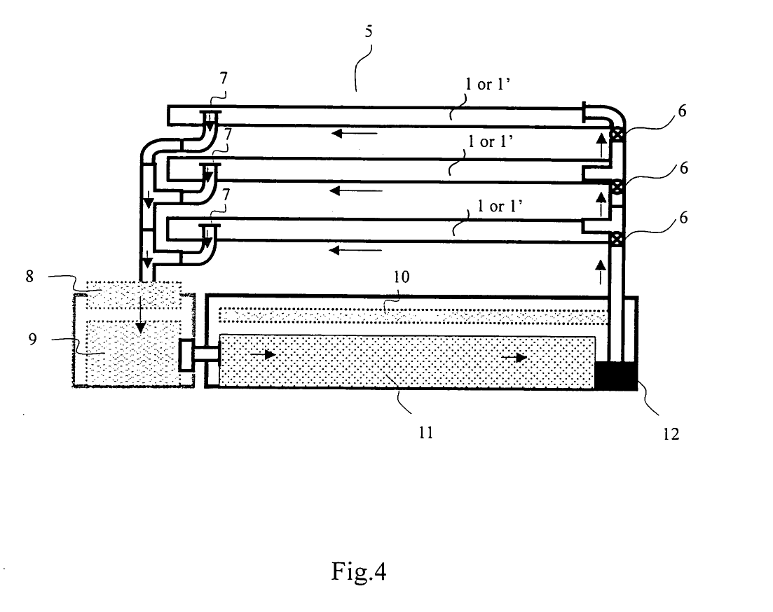

1-23. (canceled)

24. A method for cultivating and maintaining aquatic crustaceans, comprising:
obtaining live aquatic crustaceans; and
cultivating the live aquatic crustaceans in a culture tank having at least one effective resting/hiding area that provides visual only or visual and tactile both sensations for the aquatic crustaceans.

25-28. (canceled)

29. The method for cultivating and maintaining aquatic crustaceans according to claim 24, wherein said aquatic crustaceans are shrimp and crab.

30. The method for cultivating and maintaining aquatic crustaceans according to claim 29, wherein said shrimp are Litopenaeus vannamei, Penaeus monodon, and Penaeus japonicus.

31. A method for cultivating and maintaining aquatic crustaceans, comprising:
obtaining live aquatic crustaceans; and
cultivating the live aquatic crustaceans in a multi-layered culture system comprising:
a plurality of culture tanks for cultivating and maintaining aquatic crustaceans;
a plurality of porous structure each having a plurality of pores, and each said porous structure located above or inside of each said culture tank; and
a light source for providing light;
wherein partial light of said light source penetrates the pores of said porous structure and partial light of said light source is blocked by said porous structure thereby forming an effective resting or hiding area with intermixing bright and dark portions and a contrasting light effect inside said culture tank.

32. The method for cultivating and maintaining aquatic crustaceans according to claim 31, wherein said aquatic crustaceans are shrimps and crabs.

33. The method for cultivating and maintaining aquatic crustaceans according to claim 32, wherein said shrimps are Litopenaeus vannamei, Penaeus monodon, and Penaeus japonicus.
